(19) United States
(12) Patent Application Publication
(10) Pub. No.: US 2022/0050050 A1
(43) Pub. Date: Feb. 17, 2022

(54) AUTOMATED ON-LINE ACTIVE CLAY ANALYZER IN MINERAL SLURRIES

(71) Applicant: THE SASKATCHEWAN RESEARCH COUNCIL, Saskatoon (CA)

(72) Inventor: Ruijun SUN, Saskatoon (CA)

(21) Appl. No.: 17/431,112

(22) PCT Filed: Feb. 14, 2020
(86) PCT No.: PCT/CA2020/050204

§ 371 Date: Aug. 13, 2021

Related U.S. Application Data
(60) Provisional application No. 62/805,483, filed on Feb. 14, 2019.

(51) Int. Cl. G01N 21/31

(52) U.S. Cl. CPC G01N 21/31

(57) ABSTRACT

An automated active clay analyzer apparatus for analyzing active clays in a mineral slurry in a vessel or passing through a conduit, comprising a controller operable to manage the operations associated with the apparatus; an automatic sampler coupled to the vessel or conduit and operable to extract a sample of a determined volume of the slurry from the vessel or conduit, the automatic sampler being under control of the controller; at least one fluid delivery device under control of the controller and operable to deliver a known volume of water and a known volume of cationic dye into the sample; a mixing chamber that receives the sample; an agitator operable to agitate the sample, the water and the cationic dye in the mixing chamber to produce a diluted sample mixture; an automatic filter operable to filter the diluted sample mixture to produce a filtrate; and a spectrophotometer having an optical flow cell that receives the filtrate from the automatic filter and is operable to measure a spectra absorbance of the filtrate in the optical flow cell using at least one wavelength to obtain spectra absorbance data of the filtrate that may be used to control the processing of the mineral slurry or other aspects of a mineral processing operation related to the mineral slurry in near real time.

### TECHNICAL FIELD

The technical field generally relates to an on-line and automated analyzer system to identify and quantify active clay in mineral slurries by using a cationic dye as indicator, and more particularly, to an on-line and automated analyzer system to identify active clays and quantify clay activity by automatically withdrawing a slurry sample from a process, conditioning the sample in a mixing chamber and automatically extracting a filtrate from the sample after treated by Methylene Blue (MB) and other chemicals, and correlating the filtrate's spectra absorbance to clay activity, clay content and/or clay type in the original slurry. In addition, pH of the conditioned sample can be correlated to the pH of original slurry in process. These measurements can be used to achieve better process control, improve ore processability, save water and cost for tailings management, and reduce tailings volume for the mining industry.

### BACKGROUND

Clay minerals are very small particles in size (<2 μm) and have large surface areas, even a small clay fraction present in a mineral mixture can have a significant impact on the mixture properties.

Active clays are swelling clays that do not agglomerate, settle or consolidate easily when mixed with water. Active clays can cause significant challenges for effective solids-water separation and water recovery. Their presence in slurries complicates ore processing, desired element extraction, slurry pipe flow and solids settling behaviours, causing difficulties in many mineral processes, such as for example, extraction, flotation, flocculation, solid/water separation, thickening, hydrotransportation, consolidation and reclamation. Active clays exist in many minerals including kimberlite, potash, uranium, and oil sands, as well as others known in the art. In addition to mineral slurry applications, clays are also present other industrial slurry applications including drilling fluids and building materials, where an active clay analyser would also be beneficial to optimizing operations.

The Methylene Blue Index (MBI) method is a known effective measure of clay activity because methylene blue (MB) dye, a cationic dye, has strong affinity to clay edges, external surfaces and interlayers. This enables MBI to be used to measure cation exchange capacity (CEC) and other important physical properties of clay or clay mineral mixture. CEC is the quantity of cations that a clay mineral can accommodate on its negatively charged surface: the higher the CEC and MBI value, the more active the clay or the larger fraction of active clays in a clay mixture. MBI values are indicators of active clay content and clay activity, which in turn can be correlated with slurry properties such as ore processability, solid/water separation rate and solids settling behaviour. This provides the potential for MBI to be used to assist in the control of slurry process parameters such as ore blending ratio, chemical, coagulant and flocculant dosages and flowrates, pumping and mixing power and water recovery rates, as well as other parameters apparent to a person skilled in the art.

Currently MBI is measured by manual laboratory procedures based on ASTM C837-09 (Reapproved 2014). A mineral sample containing clays is treated with chemicals then titrated by MB solution. A series of droplets from the chemical treated and MB titrated sample mixture are manually transferred onto a filter paper. When a light blue halo appears around a droplet, it indicates the total MB adsorption on the surfaces of all clays in the sample and that the sample has reached the titration endpoint. The blue halo is visually detected by human eyes.

The volume of MB solution used to reach the titration endpoint, along with normality (concentration) of the MB solution and sample mass, can be used to determine MBI value of the mineral sample based on the following equation:

$$MBI = \frac{E \times V}{W} \times 100 \qquad ( 1 )$$

### Where:

MBI=methylene blue index for the mineral sample in meq/100 g;
E=milliequivalents of methylene blue per millilitre;
V=millilitres of methylene blue solution required for the titration; and
W=grams of mineral sample, dry basis.

There are many empirical MBI equations derived from this equation to be applied for specific minerals such as, for example, oil sands tailings.

Currently MB adsorption on clays is measured by laboratory procedures that require lengthy and manual sample preparation, titration and the transferring of a series of MB dyed droplets on to a filter paper. The total MB adsorption on clays is determined by visually identifying the halo, which is a light blue ring, around a droplet and interpreting it as an endpoint in titration. Hence the current MBI measurement is performed manually by off-site laboratory or via lab kit. The human detection of the titration endpoint could be subjective and erroneous as the procedure could be affected by many parameters and measuring conditions. The MBI result is discrete and available in hours or days later and is thus not suitable for near real-time process control applications. Furthermore, any on-line pH measurement on oily process slurry is challenging as oil coats the pH probe renders the measurement inaccurate or impossible.

Accordingly, an automated on-line active clay analyser apparatus and method that could provide MBI and pH measurements as close to real time as possible (near real-time) would be advantageous in order to achieve better process control of the mineral slurry and thus save water and cost for ore processing and tailings management, and reduce tailings volume for the mining industry, as well as other benefits apparent to persons skilled in the art.

### SUMMARY

Accordingly, in some aspects the present invention provides an automated active clay analyzer apparatus for analyzing active clays in a mineral slurry in a vessel or passing through a conduit, the apparatus comprising: controller operable to manage the operations associated with the apparatus; an automatic sampler coupled to the vessel or conduit and operable to extract a sample of a determined volume of the slurry from the vessel or conduit, the automatic sampler being under control of the controller; at least one fluid delivery device under control of the controller and operable to deliver a known volume of water and a known volume of cationic dye into the sample; a mixing chamber that receives the sample; an agitator operable to agitate the sample, the water and the cationic dye in the mixing chamber to produce a diluted sample mixture; an automatic filter operable to filter the diluted sample mixture to produce a filtrate; and a spectrophotometer having an optical flow cell that receives the filtrate from the automatic filter and is operable to measure a spectra absorbance of the filtrate in the optical flow cell using at least one wavelength to obtain spectra absorbance data of the filtrate that may be used to control the processing of the mineral slurry or other aspects of a mineral processing operation related to the mineral slurry in near real time. The apparatus may be on-line such that the sample is withdrawn from an on-line active process. The cationic dye may be methylene blue.

In some embodiments, the controller may be operable to instruct the automatic sampler to extract the sample from the vessel or conduit. The controller may be operable to instruct the at least one fluid delivery device to flush the sample out of the automatic sampler after the sample has been extracted by the automatic sampler.

In some embodiments, the at least one fluid delivery device may comprise a water fluid delivery device that cooperates with the automatic sampler to deliver the volume of water into the extracted sample to flush it out of the automatic sampler to clean the automatic sampler thereby ready it for obtaining a subsequent sample of slurry. The at least one fluid delivery device may be further operable to deliver a volume of one or more chemicals into the sample in or upstream of the mixing chamber to chemically condition the sample. The at least one fluid delivery device may further comprise a methylene blue dye fluid delivery device that cooperates with the mixing chamber to deliver the volume of methylene blue into the diluted sample mixture in the mixing chamber. The at least one fluid delivery device may further comprise at least one chemical fluid delivery device operable to deliver a volume of one or more chemicals into the diluted sample in the mixing chamber to chemically condition the diluted sample.

In some embodiments, the spectrophotometer may be operable to measure a spectra absorbance of the filtrate in the optical flow cell using plurality of wavelengths to obtain spectra absorbance data of the filtrate. The plurality of wavelengths may be in the range of 500 nm-800 nm.

In some embodiments, the agitator may be under control of the controller. The sonic homogenizer may be under control of the controller. The automatic filter and the spectrophotometer may each be under control of the controller. The controller may be operable to instruct the automatic filter to extract the aliquot from the mixing vessel and convey the aliquot to the flow cell of the spectrophotometer. The controller may be operable to instruct the agitator to mix the sample mixture after the sample mixture is received in the mixing chamber. The controller may be operable to instruct the spectrophotometer to measure the spectra absorbance of the filtrate after the filtrate is received in the flow cell.

In some embodiments, the automatic sampler may be mounted on the vessel or conduit and includes a sample extraction portion that communicates with an internal lumen of the vessel or conduit containing the mineral slurry. The apparatus may further comprise a sonic homogenizer to disperse clay particles in the diluted sample mixture. The sonic homogenizer may cooperate with the mixing chamber to homogenize the sample mixture in the mixing chamber.

In some embodiments, a density measuring device may be provided near the automated clay analyzer to measure the density of the slurry. A pH probe may be provided in the mixing chamber to measure the pH of the sample mixture.

In some embodiments, the at least one fluid delivery device may be operable to deliver sequential volumes of cationic dye solution into the diluted sample mixture within the mixing chamber, and the apparatus may further include a pump operable to move the aliquot from the mixing chamber through the automatic filter and the filtrate to the optical flow cell after each delivery of the cationic dye for obtaining spectra absorbance measurements of each filtrate. The controller may be operable to instruct the at least one fluid delivery device to deliver a volume of cationic dye solution into the sample mixture after an aliquot is withdrawn from the mixing chamber. The at least one fluid delivery device may be operable to flush water through the automatic sampler, mixing chamber to clean them in preparation for processing a subsequent sample.

In some embodiments, the apparatus may further comprise a temperature regulating device under control of the controller and cooperating with the mixing chamber to maintain the diluted sample mixture at a set temperature. The temperature regulating device may comprise a fluid jacket around a portion of the mixing chamber having a flow of hot fluid or cold fluid circulating through the fluid jacket.

In some embodiments, the apparatus may further comprise a memory storage media to store measurement data generated by the apparatus. A data processor may be provided that is operable to process spectral absorption data measured by the spectrophotometer for the sample and derive a methylene blue index and/or other correlations for the slurry sample from the spectra absorbance data.

In some aspects, the present invention provides a method of automatically analyzing active clays in a mineral slurry in a vessel or passing through a conduit, the method comprising the steps of: (a) providing a controller operable to manage the operations associated with the process; (b) coupling an automatic sampler with the vessel or conduit such that the automatic sampler is operable to extract a sample of a known volume of the slurry from the vessel or conduit; (c) providing instructions from the controller to the automatic sampler to extract the sample; (d) flushing the sample from the automatic sampler with a volume of water into a mixing chamber using at least one fluid delivery device under control of the controller; (e) mixing the sample and water in the mixing chamber to provide a diluted sample mixture; (f) providing instructions from the controller to the at least one fluid delivery device to add a known volume of a cationic dye into the diluted sample mixture; (g) withdrawing and filtering an aliquot of the dyed diluted sample mixture through filter media of an automatic filter and directing a filtrate of the aliquot into an optical flow cell of a spectrophotometer; (h) providing instructions from the controller to the spectrophotometer to measure spectra absorbance of the filtrate to obtain spectra absorbance data of the filtrate, and storing the data in memory; (i) repeating steps (f) to (h) until a target spectra absorbance value or a plurality of target spectra absorbance values is reached; (j) flushing water through the automatic sampler and mixing chamber to expel remnants of the slurry sample and process solutions therefrom in preparation for processing a subsequent sample; and (k) analyzing the data set and using a result of the analysis in controlling processing of the mineral slurry or other aspects of a mineral processing operation related to the mineral slurry. The cationic dye may be methylene blue and the result of the data analysis includes a methylene blue index of each sample.

In some embodiments, the method may further comprise a step of sonically homogenizing the sample mixture before and after adding dye to disperse clay particles in the sample mixture. The step of sonically homogenizing the sample mixture may be carried out in the mixing chamber.

In some embodiments, the method may further comprise a step of measuring the density of the slurry sample in the vessel or conduit near the analyzer. The method may further comprise measuring a pH of the diluted sample mixture and correlating the measured pH to a pH of the original slurry sample.

In some embodiments, the method may further comprise regulating a temperature of the dyed sample mixture in the mixing chamber under control from the controller. The step of regulating a temperature of the dyed diluted sample mixture may comprise establishing a flow of hot fluid or cold fluid through a fluid jacket provided around at least a portion of the mixing chamber.

In some embodiments, steps (c) to (j) may be repeated to obtain a data set on a desired number of slurry samples.

The foregoing summary is illustrative only and is not intended to be in any way limiting. Other aspects and features of the present invention will become apparent to those of ordinary skill in the art upon review of the following description of embodiments of the invention in conjunction with the accompanying figures and claims.

### BRIEF DESCRIPTION OF THE DRAWINGS

In drawings which illustrate by way of example embodiments of the invention:

FIG. 1 is a schematic illustration of an embodiment of an automated on-line active clay analyzer shown installed on a live slurry pipeline.

FIG. 2 is a schematic cross section of a slurry pipeline and the automated on-line active clay analyzer shown in FIG. 1 showing an automatic sampler taking a known or controlled volume of slurry sample from a live slurry pipeline (or other slurry vessel).

FIG. 3 is a cross section of the pipeline and system in FIG. 1 showing a known volume of dilution water being delivered or injected into the automatic sampler to dilute the slurry sample and transfer it into the mixing chamber.

FIG. 4 is a schematic illustration of three chemical solution containers (illustration only, not limited to three chemicals) and the mixing chamber.

FIG. 5 is a schematic illustration of the Methylene Blue (MB) solution container, mixing chamber, automatic filter and spectrophotometer.

FIG. 6 is a cross section of a slurry pipeline and the automated on-line active clay analyzer shown in FIG. 1.

FIG. 7 is a flow diagram of an embodiment of the automated on-line active clay analysis process of the present invention.

FIG. 8 is a schematic illustration of the chemical solution containers, mixing chamber and another embodiment of the automatic filter.

FIG. 9 is a schematic illustration of the Methylene Blue (MB) solution container, mixing chamber, and the automatic filter of FIG. 8, and the spectrophotometer.

FIG. 10 is a graph illustrating a series of filtrate spectra absorbances for a model clay mixture.

FIG. 11 is a graph illustrating a curve of spectra absorbance at 664 nm vs. MB volume injected for model clay mixture in FIG. 10 showing two sections of the curve can be extrapolated and the junction is the MB titration endpoint that can be used to determine the MBI value (empty circle). MBI value determined from manual titration and halo method according to the ASTM C837-09 is also plotted as reference (solid circle).

FIG. 12 is a graph illustrating a series of filtrate spectra absorbances for an industrial ore. Absorbance at 664 nm (monomer) and other peaks and dips (e.g., 610 nm dimer) provide useful information about clay surfaces and interlayers and can be used to correlate to clay activity.

FIG. 13 is a graph illustrating a curve of spectra absorbance at 664 nm vs. MB volume injected for an industrial ore in FIG. 12.

### DETAILED DESCRIPTION

An automated on-line active clay analyzer is provided to analyze clay activity and clay content of mineral slurry by measuring the filtrate spectra absorbance of the slurry sample treated with a cationic dye such as methylene blue (MB). The analyzer can be installed on a live slurry pipeline or other vessel containing slurry and can automatically take and analyze slurry samples.

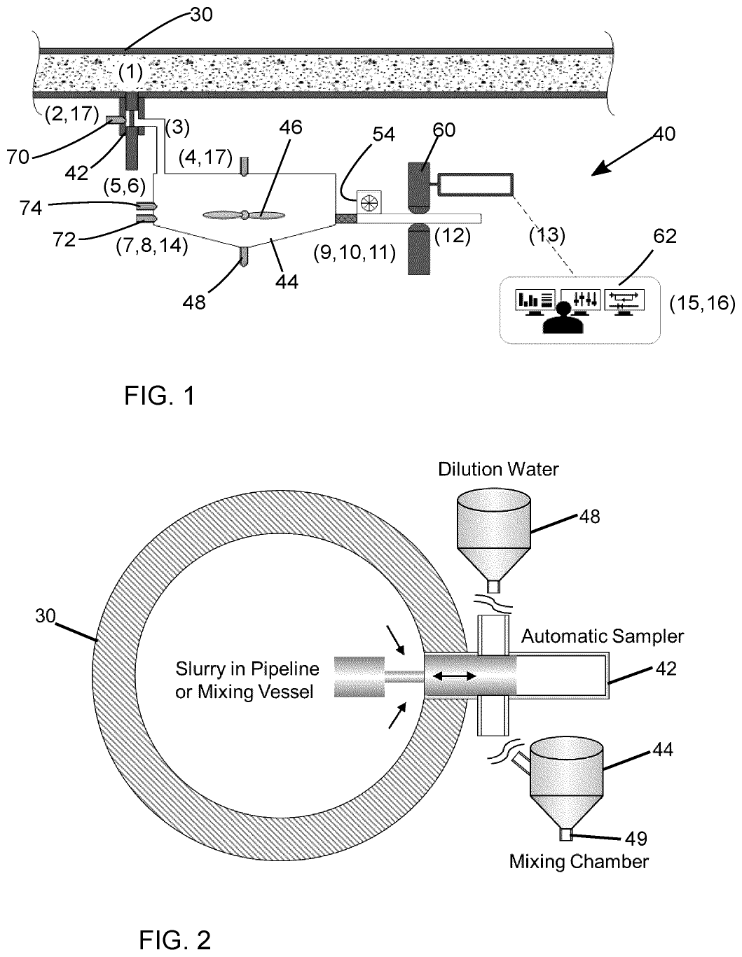

Referring to FIGS. 1-6, there is illustrated a schematic diagram of an embodiment of an automated on-line active clay analyser 40 of the present invention.

On-line active clay analyser 40 includes automatic sampler 42 that is operably mounted on a slurry pipeline 30 or other vessel, tank or conduit to withdraw a slurry sample from the flow without interfering with the operation of the pipeline. The automatic sampler 42 withdraws a known volume of the slurry sample and transfers it to mixing chamber 44. The automatic sampler is preferably remotely actuatable and controlled by a computer or other programmable controller. An example of a suitable automatic sampler 42 is an ISOLOK™ automatic sampler produced and distributed by Sentry Equipment of Oconomowoc, Wis., USA.

On-line active clay analyser 40 includes mixing chamber 44 that is downstream from and fluidly connected to the automated sampler 42. Mixing chamber 44 receives the slurry sample from the automatic sampler 42 and mixes and disperses the sample. Mixing chamber 44 may include an agitator device such as mixer impeller 46 for thoroughly mixing the diluted sample. Mixing chamber 44 may additionally include a homogenizer device such as a sonic homogenizer 47 for dispersing clay particles in the diluted sample. The sonic homogenizer may cooperate with the mixing chamber to homogenize the sample mixture in the mixing chamber. Other agitation devices or mixers may be used as would be apparent to a person skilled in the art. The agitation device and the sonic homogenizer are preferably remotely actuatable and controlled by a computer or other programmable controller.

On-line active clay analyser 40 includes a source of water such as water container 48 that is fluidly connected to the automatic sampler 42 by a fluid delivery device, which may be a dosing and metering device such as peristaltic pump, or an injector. The water container 48 supplies water to the water fluid delivery device 70 that is operable to deliver a known or controlled volume of water to the automatic sampler 42 to dilute and flush the slurry sample out of the automatic sampler 42 and convey it into the mixing chamber 44. Preferably the water fluid delivery device 70 is remotely actuatable and controlled by a computer or other programmable controller to provide said controlled volume of water to the automatic sampler 42.

On-line active clay analyser 40 may include a density measurement device installed near the analyzer (not shown) to determine the density of slurry sample in the process. The solids content of the slurry sample is determined from the volume of slurry sample taken by the automatic sampler and the density of slurry sample from the process.

The pH probe 56 measure the pH of diluted sample in the mixing chamber and use the measured pH value to determine the pH of the slurry sample in process since the water content of the sample taken by the automatic sampler is known, along with the volume and pH of dilution water. The pH probe 56 would not be coated easily by residual hydrocarbons as the sample is very diluted in the mixing chamber and the pH probe can be cleaned after each sample testing.

On-line active clay analyser 40 includes source of chemicals such as chemical containers 51, 52 and 53 that are fluidly connected to the mixing chamber 44. The source of chemicals 51, 52, 53 supplies chemicals to at least one chemical fluid delivery device 72, which may be dosing and metering devices such as peristaltic pumps, or injector, that deliver a controlled volume of one or more chemicals into the mixing chamber 44. Preferably the at least one chemical fluid delivery device 72 is remotely actuatable and controlled by a computer or other programmable controller to provide said controlled volume of chemicals to the mixing chamber 44. The chemical used in the process will vary depending on operational factors, including but not limited to the source of the mineral slurry, and the kinds of chemical used, and quantities would be apparent to those skilled in the specific field. By way of example only, the chemicals may include acids, bases or buffers to adjust the pH of the sample, conditioners to make the clay particles more sensitive to binding with MB, and/or chemicals to detach hydrocarbons from the clay particles. For example, a controlled volume of chemical solution may be delivered in series and in increments to the diluted slurry sample in the mixing chamber during mixing and sonicating to disperse solids/clay particles in the sample, and the chemical injection continues until a target pH value is reached as measured by the pH probe. The pH probe also determines the pH of diluted sample before chemical injection, which can be used to determine the pH of slurry sample in the process as the volume and pH of dilution water are known. Advantageously, the pH probe will not be coated by residual hydrocarbons easily because the sample in the mixing chamber is very diluted and the pH probe can be automatically cleaned after each sample testing. While three sources of chemical are illustrated, the scope of the invention is not bound thereto as any number of chemical containers and fluid delivery devices may be used as necessary for desired conditioning of the diluted slurry sample.

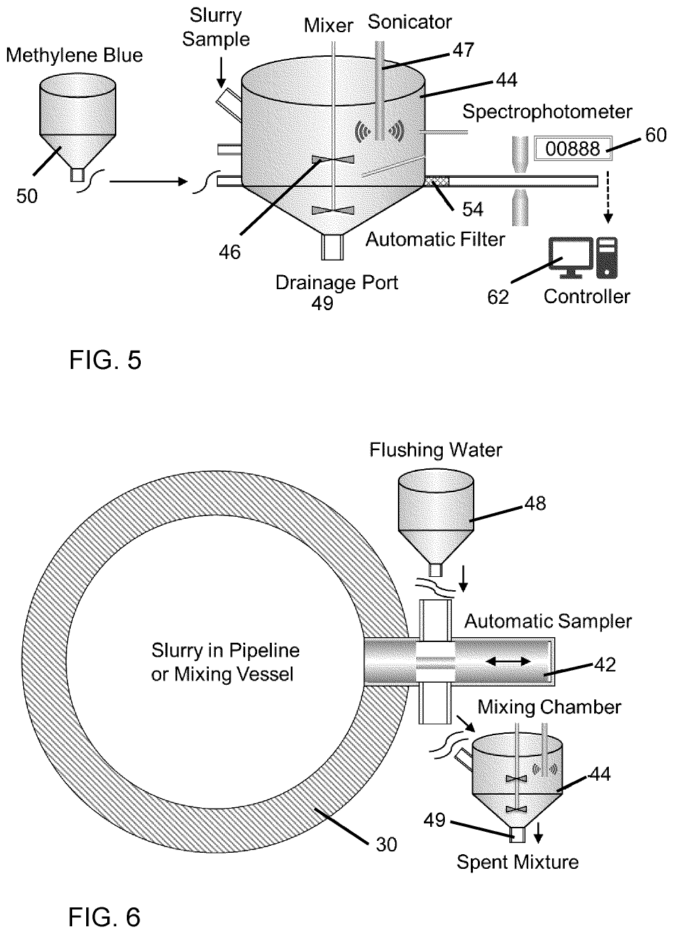

On-line active clay analyser 40 includes a source of cationic dye solution 50 that is fluidly connected to the mixing chamber 44. A fluid delivery device such as dye fluid delivery device 74 delivers or injects a controlled volume of cationic dye solution into the mixing chamber 44. The fluid delivery device 74 may be a dosing and metering device such as peristaltic pump. Preferably the dye fluid delivery device 74 is remotely actuatable and controlled by a computer or other programmable controller to provide said controlled volume of cationic dye solution to the mixing chamber 44. A preferred cationic dye is methylene blue (MB), and an example of a source of cationic dye is MB solution container 50 (FIG. 5).

Collectively, the water fluid delivery device 70, the at least one chemical fluid delivery device 72 and the dye fluid delivery device 74 comprise an at least one fluid delivery device referred to elsewhere herein.

Accordingly, mixing chamber 44 is operable to receive the diluted slurry sample from the automatic sampler 42, a controlled volume of chemicals from the chemical containers 51, 52 and 53, a controlled volume of methylene blue from the methylene blue container 50, and thoroughly mix these compounds into a sample mixture.

In some embodiments, mixing chamber 44 includes a thermal jacket through which either a heated or chilled coolant fluid may be circulated to regulate the diluted sample mixture to a desired temperature, which may be measured by a temperature probe mounted on the mixing chamber.

In some embodiments, mixing chamber 44 includes a pH probe 56 for sensing the pH of the sample mixture, and the pH probe 56 may be coupled to a feedback mechanism for regulating the volume of chemicals dispensed into the mixing chamber 44 from the source of chemicals.

On-line active clay analyser 40 includes automatic filter 54 mounted on the mixing chamber 44 and containing porous filter element through which an aliquot of analyte is filtered after being conditioned and processed in mixing chamber 44. The automatic filter 54 is operable to remove solid particulate from the sample mixture and allow only the liquid filtrate to pass therethrough. Porous working filter element may comprise a membrane or metal mesh screen with pore size suitable for the mineral sample to be analyzed. A guard filter may be provided upstream of the working filter to screen large particles and/or hydrocarbon droplets and thereby prolong the life of the working filter. A protective shield or mesh screen 55 may be provided near the automatic filter to minimize foam or froth entering the automatic filter when testing oily samples with residual oil or bitumen.

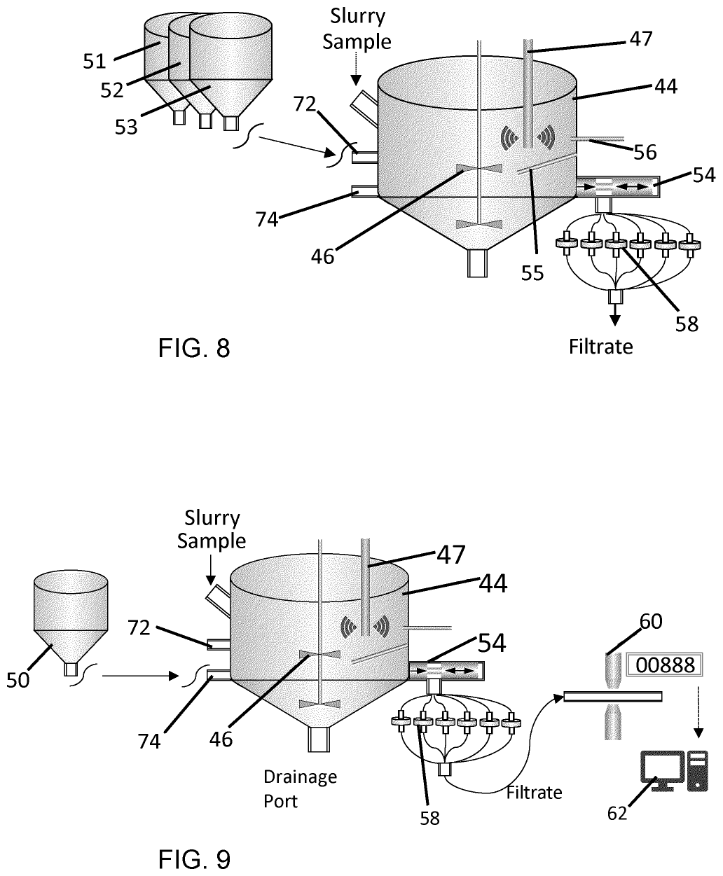

Referring to FIGS. 8 and 9, an embodiment of an automatic filter 54 may comprise an ISOLOK™ automatic sampler of a style that as a plunger of the sampler that retracts, the front end of plunger collapses and generates pressure. This automatic sampler is coupled to the mixing chamber 44 so that it extracts an aliquot of the MB dyed diluted sample mixture from the mixing chamber 44, and that is further coupled to one or more filter media or element 58. Once the aliquot of the dyed diluted sample mixture is extracted, as the plunger of the sampler device retracts the front end of plunger collapses and generates pressure to propel the aliquot through the tubing and against a disposable filter media to generate particle free filtrate. The system automatically replaces the disposable filter media with fresh filter media when it has become fouled. In one embodiment automatic filter may have a tray of 8-10 disposable syringe filters 58, each connect to a central tubing connect to the outlet of the second automatic sampler. When the controller detects the pressure has reached a threshold of pressure resistance from one syringe filters 58 due to fouling, it will automatically switch to the next fresh filter 58. While the foregoing is an example of an automatic filter 54, other embodiments of an automatic filter may be used that can extract multiple aliquots, filter them into filtrates and convey the filtrates to the spectrophotometer.

On-line active clay analyser 40 includes spectrophotometer 60 having an optical flow cell that receives the filtrate from the automatic filter 54. Spectrophotometer 60 is operable to measure the spectra absorbance of the filtrate in the flow cell at a range of wavelengths. The spectra absorbance data is transmitted to a computer or programmable controller 62 for computational analysis. A suitable spectrophotometer 60 for use in the present invention includes but is not limited to a Unico SQ4802 UV-Vis spectrophotometer distributed by Cole-Parmer. A suitable flow cell for use in the present invention includes but is not limited to a Model S-90-346FQ distributed by Cole-Parmer. The spectra absorbance data is correlated against the MB volume and other parameters determined by devices available to the analyzer system, can be used to determine the MBI value of the slurry sample and clay activity, content and/or type. The MBI value may be used on its own or in conjunction with other parameters to control processing of the slurry.

As schematically shown in FIG. 5, a controlled volume of MB may be delivered or injected in increments to the sample during mixing and sonicating. After each MB solution injection, an aliquot of analyte is withdrawn from the mixing chamber through the automatic filter, and the filtrate spectra absorbance is measured by spectrophotometer and the data transmitted to a computer.

The illustrated embodiment of an automated on-line active clay analyzer is used to analyze clay activity and clay content of mineral slurry by measuring the filtrate spectra absorbance of the slurry sample treated with a cationic dye such as methylene blue (MB). The analyzer can be installed on a live slurry pipeline or other vessel and can take and analyze slurry samples automatically and continuously. The analyzer system comprises an automatic sampler, a mixing chamber equipped with an agitation device, a sonic homogenizer, a pH probe, a temperature probe, and a temperature controlling device such as thermal jacket to regulate the temperature of the sample mixture, an automatic filtration device, a spectrophotometer with a flow cell, a data transmitter, a computer, containers and dosing and metering devices such as peristaltic pumps to supply dilution water, chemicals and MB solutions, and a density measurement device installed near the analyzer.

The on-line active clay analyzer provides a new Methylene Blue Index analyzing method that utilizes a spectrophotometer to measure the filtrate spectra absorbance as a replacement of the conventional visual halo detection procedures outlined by ASTM C837-09. The analyzer can be used automatically and continuously, and it improves the accuracy by eliminating human subjective titration endpoint determination. Furthermore, the filtrate spectra absorbance data, even before and/or after reaching the titration endpoint, can be used for correlation and process control, which can replace or supplement the titration endpoint detection and shorten the sample measuring and reaction time.

A slurry sample is taken by the automatic sampler 42 from a live pipeline or mixing vessel 30 and transferred into the mixing chamber 44 by injecting a controlled volume of dilution water from water container 48. The diluted sample is dispersed by an agitation device (mixer impeller 46) and sonic homogenizer 47 in the mixing chamber 44 and is conditioned with chemicals from the chemical containers 51, 52 and 53 until, for example, the diluted sample reaches a target pH as measured by the pH probe 56. While mixing and sonicating, MB solution is injected in increments into the sample mixture from the MB container 50. After each MB injection, mixing and dispersing, a small aliquot of the sample is withdrawn from the mixing chamber through the automatic filter 54. The filtrate from automatic filter 54 is transferred either by the pressure generated from the automatic filter 54 or by a dosing and metering device such as peristaltic pump to the spectrophotometer 60 via an optical flow cell where the spectra absorbance of the filtrate is measured. The injection of MB solution and the spectra absorbance measurement of each aliquot taken after each such MB injection will continue until the spectra absorbance measurement indicates that an titration endpoint and/or target absorbance value have been reached, which indicates total adsorption of MB by the clay surfaces, or until enough spectra absorbance data is obtained to be useful in deriving an MBI value or its correlation. The spectra absorbance and MB volume injected, along with mass of solids in the sample which is determined by the fixed volume of sample taken from the process and sample density measured by a density measurement device mounted near the analyzer, can be correlated to determine the slurry clay activity, MBI value and clay content, or to compare to a set point so that active clays in mineral mixture can be quickly identified and quantified to achieve effective process control and tailings management.

Referring to FIG. 6 there is shown a schematic cross section of a slurry pipeline and the automated on-line active clay analyzer shown in FIG. 1. After the MBI value and/or filtrate spectra absorbance vs. MB volume correlation are determined, a controlled volume of dilution water, or flushing water, is injected into the mixing chamber via the automatic sampler to flush out and discharge the spent slurry sample through a drainage port 49 at the bottom of mixing chamber. The flushing water also cleans the automatic sampler, mixer impeller, sonication probe, pH and temperature probes, automatic filter, and the mixing chamber interior while mixing and sonicating. After the flushing, the analyzer is ready to extract and analyze the next sample. While the flushing water is described and illustrated herein as being introduced into the system via the automatic sampler, in other embodiments the flushing water may be introduced into the system from another source of water and/or via another path through the system. Furthermore, in some embodiments a solvent may be added to the flushing water to dissolve hydrocarbon residues in application where hydrocarbon fouling of the parts of the apparatus occurs. And while a single filter media may be used for multiple aliquots, the system controller will periodically direct the system to switch the filter media to a fresh one when it detects the pressure upstream of the filter media has reached a threshold due to fouling of the filter media.

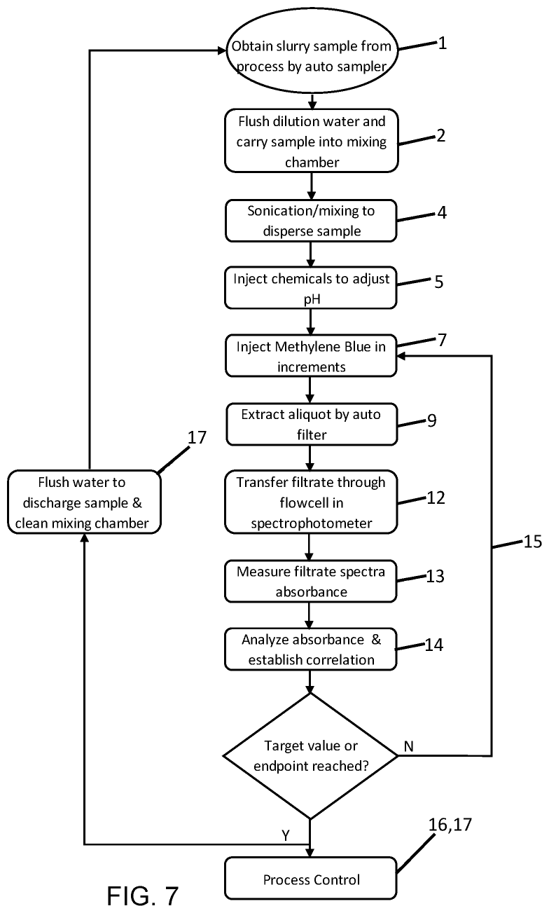

With reference to the numbered analysis steps in FIGS. 1 and 7:

At step 1, the automatic sampler takes a controlled volume of slurry sample from a live slurry pipeline or mixing vessel at controlled time intervals (FIG. 2).

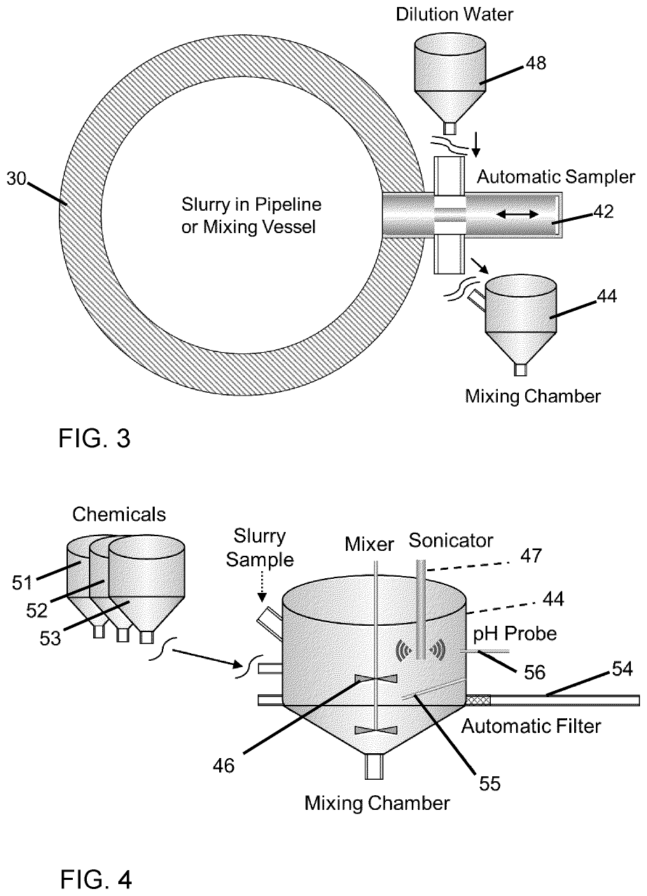

At step 2, a controlled volume of dilution water is injected into the automatic sampler and flushes the slurry sample into the mixing chamber (FIG. 3).

At step 3, the dilution water is dispensed by a peristaltic pump controlled by the computer/controller.

At step 4, the mixing chamber is equipped with a mixer, a sonication probe, a pH probe, a thermal jacket circulating with either heated or chilled coolant to regulate the sample mixture temperature which is measured by a temperature sensor. The mixer and sonication probe are engaged to disperse clay particles and enhance reaction (FIG. 4). A density measurement device is installed near the analyzer.

At step 5, while mixing and sonicating, a controlled volume of chemical solutions is injected in series and in increments to the diluted slurry sample until a target pH value is reached as measured by the pH probe. The chemical injection volume is controlled by the pH measurement (FIG. 4) and a controller.

At step 6, the chemical solutions are dispensed by the respective dosing and metering devices or peristaltic pumps controlled by the computer/controller.

At step 7, while mixing and sonicating, a controlled volume of MB solution is injected in increments to the chemically conditioned slurry sample (FIG. 5).

At step 8, the MB solution may be dispensed by a dosing and metering device or peristaltic pump controlled by the computer/controller.

At step 9, after each MB solution injection and mixing, an aliquot of analyte is withdrawn from the mixing chamber through the automatic filter (FIG. 5).

At step 10, the filtrate is generated through the automatic filter.

At step 11, the filter media composed of either a membrane or syringe filter or metal mesh screen with pore size suitable for the mineral sample to be analyzed.

At step 12, the filtrate analyte is transferred through an optical flow cell of spectrophotometer by either the pressure from the automatic filter or by a peristaltic pump.

At step 13, the filtrate is measured by the spectrophotometer at a pre-recalibrated wavelength or a range of wavelengths and the spectra absorbance data is transmitted to a computer (FIG. 5).

At step 14, the filtrate spectra absorbance value and injected MB solution volume, along with slurry solids concentration (or density), normality (concentration) of MB solution, solids and liquid densities of the sample measured by other instruments installed on the system, are correlated and used to determine the sample's MBI value and/or the slurry's clay activity, content and/or type.

At step 15, the MB solution injection continues until either reach a target spectra absorbance value (titration endpoint) which indicate a total adsorption of MB on the clay surfaces, or enough filtrate spectra absorbance data is generated to enable correlation to the clay activity based on pre-calibration curves.

At step 16, the clay activity and content are used as input variables for feedback (step 16) or feed forward (step 17) schemes for controlling the process parameters, such as but not limited to, ore blending ratio, chemical coagulant and flocculant dosages, slurry and/or flocculant mass or volumetric flowrates, etc.

At step 17, after the MB injection into the diluted slurry sample is completed in step 15, a controlled volume of flushing water is delivered or injected into the mixing chamber via the automatic sampler to remove the spent slurry sample through a drainage port 49 at the bottom of mixing chamber (FIG. 6). The flushing water also cleans the automatic sampler, the agitator or mixer impeller, the sonic homogenizer (such as sonication probe) and pH probe, the automatic filter, and the mixing chamber interior by engaging the mixer and sonication probe; the analyzer is ready to analyze the next sample (FIG. 6). Preferably, the apparatus automatically replaces the to the disposable filter media with fresh filter media when it has become fouled. with a fresh filter.

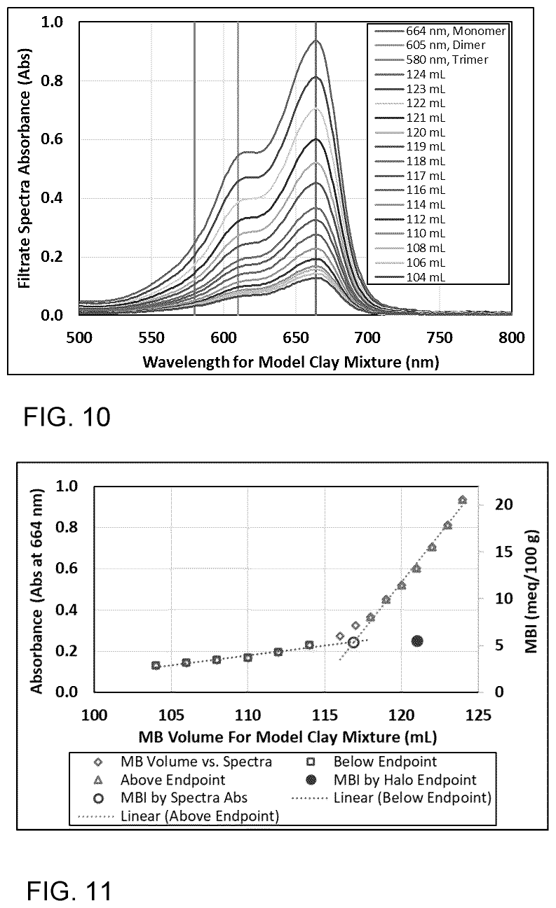

Referring to FIG. 10, there is shown a series filtrate spectra absorbances measured by spectrophotometer in accordance with the present invention for MB treated model clay mixtures with a mixture of kaolinite (non-active clay), sodium bentonite (active clay) and silica flour (Sil 325). FIG. 10 shows a series filtrate spectra absorbances vs. wavelength as a function of MB volumes injected, increasing the MB injection volume increases the spectra absorbance until passing the titration endpoint. Also showing in FIG. 10 are specific wavelengths corresponding to MB sub-compounds such as monomer (MB⁺ at 664 nm), dimer ((MB⁺)₂ at 610 nm) and trimer ((MB⁺)₃ at 580 nm). Absorbance at 664 nm (monomer) has the most sensitive peak for this clay mixture, but other peaks and dips (e.g., 610 nm dimer) provide useful information about clay surfaces and interlayers.

Referring to FIG. 11 there is shown a graph illustrating a curve of filtrate spectra absorbance at 664 nm as a function of MB volume injected for the same model clay mixture in FIG. 10. The filtrate spectra absorbance shows two distinctive curves, each can be extrapolated and cross at a junction that is the titration endpoint. This endpoint from the spectra absorbance curves can replace the prior art halo determined titration endpoint and can be used to determine the MBI value (empty circle). Also shown in FIG. 8 is the MBI value (solid circle) measured by the prior art manual titration and halo identification method based on ASTM C837-09.

The endpoint determined by either spectra absorbance or halo identification is an indication that the clay edges, external surfaces and interlayers being adsorbed by the dye molecules MB such that free dye MB molecules remain in solution and thereby cause an increase in spectra absorbance or appear as a halo around the droplet on filter paper in the ASTM C837-09 method.

In the present invention, the range of increase in filtrate spectra absorbance may be correlated to the volume of MB solution injected and used to derive an MBI value and/or to correlate to the clay activity and active clay content in the sample, in such case, the titration endpoint or true value of MBI may not be needed to shorten the measurement time and to improve responses.

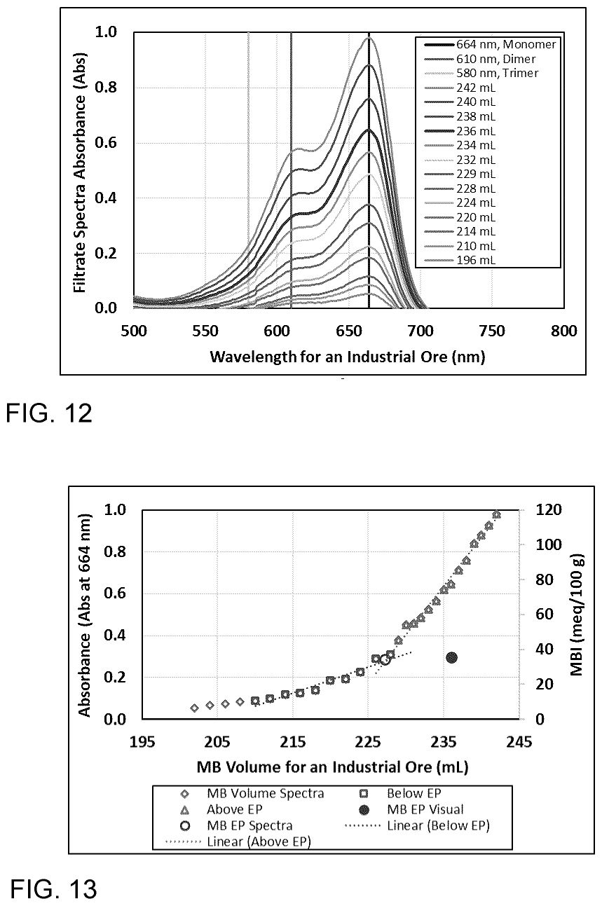

Referring to FIG. 12, there is shown filtrate spectra absorbances measured by spectrophotometer in accordance with the present invention for MB treated industrial ore which contains active clays causing difficulties to solids water separation and challenges to tailings management. FIG. 12 shows a series of filtrate spectra absorbances vs. wavelength as a function of MB volumes injected, increasing the MB injection volume increases the spectra absorbance until passing the titration endpoint. Also showing in FIG. 12 are specific wavelengths corresponding to MB sub-compounds such as monomer (MB+ at 664 nm), dimer ((MB+)2 at 610 nm) and trimer ((MB+)3 at 580 nm).

Referring to FIG. 13, there is shown the filtrate spectra absorbance at 664 nm as a function of MB volume injected for the same industrial ore in FIG. 12. The filtrate spectra absorbance shows two distinctive curves, each can be extrapolated and cross at a junction that is the titration endpoint, which can replace the halo determined titration endpoint and used to determine the MBI value (empty circle). Also shown in FIG. 13 is the MBI value (solid circle) measured by the current manual titration and halo identification method based on ASTM C837-09.

The endpoint determined by either spectra absorbance or halo identification is an indication that the clay edges, external surfaces and interlayers being adsorbed by the dye molecules MB such that free dye MB molecules remain in solution and thereby cause an increase in spectra absorbance or appear as a halo around the droplet on filter paper in the ASTM C837-09 method.

In addition, the pH of the slurry sample taken from on-line process can be determined by measuring the pH of diluted sample in the mixing chamber, since the water content in the sample can be measured by the sample volume and the density measurement device installed near the analyzer, and the pH and volume of the dilution water that carry the sample into the mixing chamber are known. The pH probe will not be easily coated by residual hydrocarbons since the sample in mixing chamber is very diluted and the pH probe can be cleaned after each sample testing. An apparatus that comprises an automatic sampler such as automatic sampler 42, a dilution water delivery device such as dilution water delivery device 70, a mixing chamber such as mixing chamber 44 and a pH probe in the mixing chamber such as pH probe 56, provides a novel online automated pH determining apparatus for determining the pH of a slurry in a vessel or passing through a conduit.

The automated, on-line active-clay analyzer in accordance with the present invention is operable to analyze clay activity, clay content and clay type for mineral slurry by measuring the spectra absorbance of filtrate extracted from the slurry sample treated with a cationic dye, preferably methylene blue (MB). The analyzer may be installed on a live slurry pipeline or mixing vessel to analyze slurry sample automatically. The analyzer system may comprise an automatic sampler; a mixing chamber equipped with an agitate device, an sonic homogenizer, a pH probe, a temperature control apparatus for managing the temperature of the mixture, a temperature probe, an automatic filter, a spectrophotometer with an optical flow cell; a data transmitter; a computer and controllers for the devices; containers and dosing and metering devices to supply dilution water, solutions for chemicals and MB; and a density measurement device installed near the analyzer.

Slurry samples of a known or controlled volume may be taken by the automatic sampler from a live process and conveyed or flushed into the mixing chamber with a known or controlled volume of dilution water from a source of water. The diluted sample may be dispersed in the mixing chamber by an agitation device, such as a mixer, and a sonic homogenizer, and the diluted sample may be conditioned by injecting chemical solutions in increments until the diluted sample reaches pH targets. MB solution is injected in increments into the sample. After each MB injection and dispersing, a small aliquot is filtered by an automatic filter and measured by a spectrophotometer. The spectra absorbance of the filtrate may be used to determine the slurry clay activity, clay content and/or clay type for mineral process control.

The present invention provides close to real-time (near real-time) identification and quantification of active clays to enable blending feed ores at right ratios based on active clay contents, dosing chemical and/or flocculant to treat feed streams as well as tailings, improving mineral extraction and slurry dewatering and solids-water separation, recovering more desired ingredients and water, reducing tailings volume and saving cost for processing and future land reclamation.

An automatic sampler in the automated, on-line active-clay analyzer may be configured to withdraw a fixed volume of slurry sample from a live pipeline or vessel. A water container may be provided that is operable to hold water used to dilute the slurry sample after it has been extracted by the automatic sampler, as well as to flush out the apparatus after the sample analysis thereby readying it for a subsequent sample. A controlled volume of dilution water may be dispensed into the automatic sampler by the dosing and metering device to flush out the slurry sample and carry the diluted slurry sample into a mixing chamber that is provided with or coupled to an agitation device, a sonic homogenizer, a pH probe, a temperature probe, and a temperature control apparatus. Chemical solution containers may be provided that hold chemical solutions that may be dispensed in controlled volumes by additional respective dosing and metering devices.

A density measuring device may be provided to measure the slurry density (ρₘ). Using the following equations, the mass of solids in the sample that is used for MBI calculation is determined from the fixed volume (Vₘ) of the sample taken by the automatic sampler, solids density (ρₛ) and liquid density (ρ_{L}) both are available by pre-determination, and the slurry mixture density (ρₘ) measured by the density device.

$$\begin{matrix}{C}_{w} = \frac{{ρ}_{s} * ( {ρ}_{m} - {ρ}_{L} )}{{ρ}_{m} * ( {ρ}_{s} - {ρ}_{L} )} & ( 2 ) \\ {W}_{s} = {ρ}_{m} * {V}_{m} * {C}_{w} & ( 3 ) \\ {W}_{L} = {ρ}_{m} * {V}_{m} * ( 1 - {C}_{w} ) & ( 4 )\end{matrix}$$

### Where:

C_{w}=mass fraction of solids in slurry
ρₛ=density of solids in kg/m³
ρₘ=density of slurry in kg/m³
ρ_{L}=density of liquid in kg/m³
Vₘ=volume of slurry sample in mL
Wₛ=mass of solids in sample in grams
W_{L}=mass of liquid in sample in grams

The density of the extracted slurry sample may be measured by a nuclear density device installed near the analyzer so the solids and water content of the sample can be determined and used in conjunction with the known volume of automatic sampler.

The diluted slurry sample is mixed in the mixing chamber by an agitation device and the solid particles in the sample are dispersed by a sonic homogenizer. The temperature of the diluted sample in the mixing chamber is regulated by the temperature control apparatus.

While mixing and sonicating takes place in the mixing chamber, controlled volumes of chemical solutions are dispensed in increments into the mixing chamber by the respective dosing and metering devices until the pH of the slurry, as measured by a pH probe, reaches a target value.

The mixing and sonication continue for a target duration that may be determined by pre-calibrations. A MB solution container is provided that contains the MB solution, which may be dispensed by another dosing and metering device into the diluted sample in the mixing chamber. A controlled volume of MB solution is injected in increments and dispersed into the slurry mixture. After each MB solution injection and mixing/sonication as may be required, an aliquot of the dyed diluted sample mixture, also referred to herein as the analyte, is filtered by an automatic filter, and the resulting filtrate may be transferred into an optical flow cell of a spectrophotometer. The filtrate's spectra absorbance is measured by the spectrophotometer and the data is transmitted to a computer for storage and computational analysis. The data may also be used to control the operation of the automated on-line active-clay analyzer.

The steps of MB solution injection to the sample mixture, filtrate removing and measuring by the spectrophotometer are repeated to obtain a series of spectra absorbance data for processing by the computer. The MB solution injection is stopped after the filtrate spectra absorbance reaches a target value, or the titration endpoint, or enough spectra absorbance data is obtained to enable useful correlation. The titration endpoint and/or the spectra absorbance obtained before and/or after reaching the titration endpoint, along with other parameters determined (e.g., volume and normality of MB solution injected, density and temperature of the slurry, densities of solids and process liquid, particle size distributions of the solids sample, as well as others) by other instruments in the system, may be used to correlate and determine the clay MBI value, clay activity and content, and the like.

After an MBI value is determined, a controlled volume of wash water may be flushed into the automatic sampler and through the mixing chamber to wash out the spent sample mixture through a drainage port that may be provided at the bottom of the mixing chamber. The wash water cleans the automatic sampler, agitation device, sonic homogenizer, pH probe, temperature probe, automatic filter and the interior of the mixing chamber while the agitation device, the sonic homogenizer and automatic filter are preferably actuated to assist in the wash process. After the water flush, the on-line active analyzer is ready to process and analyze another slurry sample.

The chemical solution containers may be configured to receive and hold each chemical solution in respective container and configured to dispense a controlled volume of chemical solution in series and in increments to the mixing chamber. The slurry sample and dilution water are mixed in the mixing chamber by an agitation device and the clay particles in the slurry are dispersed by a sonic homogenizer. While the mixing and sonicating occur, a controlled volume of each chemical solution is dispensed in sequence and in increments by the respective dosing and metering device into the diluted sample mixture until the pH measured by the pH probe reached the target value. The mixing and sonication continue until it reaches the target time duration and power intensity based on pre-calibrations. The operation injection of the chemicals and the mixing and sonication are controlled by a computer.

The pH of the diluted sample mixture, before adding chemicals, may be measured and correlated to the pH of raw slurry sample withdrawn from the process by the automatic sampler since the water content of the sample can be determined by Equations 2-4 listed above and the pH and volume of the dilution water that carry the sample into the mixing chamber can be measured and is known respectively. Advantageously, the pH probe in the mixing chamber would not be coated easily by hydrocarbons from the sample since the sample is very diluted. This addresses the problem in the prior art identified above of determining the pH of an oily slurry in the process stream as a result of fouling of pH probes by oil. As well, residual bitumen or oil in the sample will not coat the pH probe since the pH probe may be automatically cleaned after each sample measurement by the water flush through the mixing chamber.

In some embodiments of the on-line automated active clay analyzer an automated filter mechanism may be coupled to the side wall of the mixing chamber and is operable to withdraw an aliquot of the analyte from the mixing chamber after each MB solution injection and mixing/sonication. A dosing and metering mechanism may be connected to the automatic filter and is operable to convey the filtrate from the automatic filter through the optical flow cell of the spectrophotometer, where the filtrate is measured by the spectrophotometer and the spectra absorbance data is transmitted to a computer and a controller. However, in some embodiments, an automatic filter may be used that generates pressure that can be used to convey the filtrate through the optical flow cell such that no dosing and metering device is required.

The steps of the MB solution injection to the diluted sample mixture in mixing chamber, filtrate generation by the automatic filter, and spectra absorbance measuring by the spectrophotometer may be repeated several times to provide spectra absorbance data for each repetition. The spectra absorbance data may be transmitted to the computer for computational analysis to determine a titration endpoint, which can be correlated with the MB volume injected and the mass of solids in the slurry sample to determine the MBI value.

The spectra absorbance curve can be correlations to determine the clay activity and/or clay content for process control because curves containing more information than a single endpoint; the change of peaks and dips on each curve can also be used to indicate clay type and overall clay compositions in near real-time rate. This provides broad information to operators to inform process control beyond just a single MBI endpoint.

The MB solution injection stops after the filtrate spectra absorbance reaches a target value and/or titration endpoint. The spectra absorbance data, along with other parameters measured by other instruments available to the system (e.g., volume and normality of MB solution injected, density and temperature of the slurry, particle size distributions of the solids sample, volume of the sample withdrawn, densities of solids and process liquid), as well as other parameters, may be used to determine the clay MBI value for broader applications.

After an MBI value is determined and/or clay activity/clay content is correlated, another controlled volume of dilution water (flushing water) is injected by the dosing and metering device from the dilution water tank to the automatic sampler and through the mixing chamber to wash the spent sample mixture out of the mixing chamber via the drainage port at the bottom of mixing chamber. An additional mechanism may be configured to wash the agitation device and/or impeller, sonic homogenizer, pH probe and the automatic filter by engaging the mixer and sonic homogenizer. After the flushing water, the mixing chamber and its accessories are clean and ready for the next sample.

The dilution water may be dispensed in increments to the automatic sampler by a peristaltic pump connecting the holding container to the automatic sampler. Valves and a flowmeter may further be provided on the outlet of the dilution water container.

The automatic sampler and the automatic filter may be pneumatically driven by compressed air, or they may be electrically and mechanically driven via a gear mechanism. The operation of the automatic sampler and automatic filter are controlled by a controller or computer.

The mixing chamber may include an inlet ports for the slurry sample, chemicals and MB solution. The mixing chamber may include an outlet port for the automatic filter on the side wall and a drainage port at the bottom for escape of the flushing water and sample residue during the flushing operation. The mixing chamber may be equipped with a mixer, a sonication probe, online pH and temperature probes, and the automatic filter. A protective shield may be installed above or a protective screen is installed around the automatic filter where it communicated into the mixing chamber to minimize the possibility of oily foam and froth getting into the automatic filter in the event oily sample containing oil or bitumen is being analysed.

The volume of slurry sample extracted from process by the automatic sampler may be pre-calibrated and the volume and pH of dilution water that dilutes the sample and carries it into the mixing chamber is pre-determined.

The density of the slurry sample withdraw from the process may be measured by a nuclear density device installed near the analyzer so the solids and water content of the sample can be determined along with the volume of automatic sampler.

The pH of the slurry in the process may be determined by measuring the pH of diluted sample in the mixing chamber, along with solid and water contents of the sample that are determined from the previous steps, pH and volume of the dilution water. Residual bitumen or oil in the sample will not coat the pH probe easily since the sample is very diluted in the mixing chamber and the pH probe can be automatically cleaned after each sample measurement.

The chemical solution may be dispensed in series and in increments to the mixing chamber by a peristaltic pump connecting the holding container and the mixing chamber. Valves and a flowmeter may be provided on the outlet of each chemical solution holding container.

The MB solution may be dispensed in increments to the mixing chamber by a peristaltic pump connecting the holding container to the mixing chamber. Valves and a flowmeter may be provided on the outlet of the MB solution holding container.

Methylene blue (MB) may be preferably used as an active clay indicator, but other cationic dyes such as chrysoidine (basic orange) or methyl violet (basic violet) may be used as an active clay indicator.

The sonic homogenizer may be a sonication probe inside the mixing chamber, but it may also be an ultrasonic tank bath that can host several mixing chambers.

The agitation device may be a top-down mixer with a shaft and impellers. The mixer may be configured to engage with the sample mixture before sonication and after each chemical and MB injection. Both mixer and sonic homogenizer may be engaged simultaneously with the sample mixture.

The temperature of the mixing chamber may be regulated by a temperature control device such as for example a thermal jacket around a portion of the mixing chamber through which either heated or chilled coolant fluid is circulated and may be under control from a controller. Other temperature control devices would be apparent to the person skilled in the art.

The automatic filter may include a disposable membrane filter or syringe filter (pore size of 0.4 μm to 1.5 μm), which may be replaced periodically, or a metal mesh screen may be provided that is durable. The membrane material can be Nylon, PVDF, cellulose acetate, and other suitable filter media apparent to those skilled in the art. The filter elements may be suitable for multiples charges of aliquots of the dyed diluted sample mixture but once a filter element becomes fouled or clogged with residue, the resulting pressure increase upstream of the filter element may be used as a cue to change the filter element or to divert the flow of a subsequent aliquot to a fresh filter element. An additional mechanism may be configured to automatically change the filter element after multiple filtrations. A guard filter of coarser pore size ranging from 5 to 30 μm may be placed upstream of the working filter to screen off larger particle or hydrocarbon droplets thereby to prolonging the life of the working filter. The working filter media may have pore sizes in the range of 0.4 μm to 1.5 μm but is not limited thereto. The guard filter may have a coarser pore size in the range of 2 to 30 μm but is not limited thereto. The additional mechanism may be further configured to automatically switch to a new filter after multiple filtrations. Periodically, when the apparatus detects that a filter has become fouled, it will automatically replace the filter with a fresh one.

The filtrate may be transported through the spectrophotometer flow cell by the pressure generated from the automatic filter and no additional peristaltic pump is required. Alternatively, the filtrate may be pumped through the flow cell by a peristaltic pump. An additional cleaning mechanism may be provided that automatically cleans the optical flow cell by periodically injecting cleaning fluids through it.

The filtrate spectra absorbance may be measured by the spectrophotometer and the data may be transmitted to a computer. The spectrophotometer scans each filtrate and generate spectra absorbance from a range of wavelength, e.g., from 500 nm to 800 nm. Each absorbance curve has a peak or peaks and dips at distinguished wavelength(s) and the absorbance value at each peak or dip can be related to MB sub-compounds such as MB⁺ (MB monomer at 664 nm), (MB⁺)₂ (MB dimer at 610 nm) and/or (MB⁺)₃ (MB trimer at 580 nm). The increase or decrease of the MB sub-compounds in aqueous phase can be correlated to the clay surface and interlayer properties and used to determine the type and relative quantity of clay and active clay in the mixture.

The data of filtrate spectra absorbance at a specific wavelength, for example corresponding to the MB sub-compounds, can be used to develop distinctive curves of spectra absorbance vs. MB titration volumes and the curves can be extrapolated to determine the titration endpoint and the MB volume injected at the titration endpoint, along with normality of MB solution and sample solids mass determined from slurry sample volume and slurry density, these parameters can be used to determine the MBI value of the sample, or to correlate to clay activity and clay content in the sample.

The filtrate spectra absorbance or the slope of the spectra absorbance vs. injected MB volume curve reaches a target value set by pre-calibrations. The rate of change (slope) of the spectra absorbance vs. injected MB volume curve is part of the measurement which can be correlated and used to estimate the clay activity and active clay content for process control purpose, the titration endpoint and true clay MBI value may not be required to reduce measurement time and improve response to process parameter change.

The clay MBI value, and/or slurry clay activity and active clay content can be used as input parameters for the feedback or feed forward control schemes to assist the controlling of slurry process parameters such as ore blending ratio, chemical/flocculant dosages, slurry and flocculant flowrates, pumping and mixing power, solids settling and water recovery rates, as well as other parameters.

The filtrate spectra absorbance measured by the spectrophotometer may provide the controller signals that the controller will control the MB solution injection process and/or to terminate the titration, and the filtrate spectra absorbance may provide the controller signals that the controller will adjust the volume of chemical solution injection. The filtrate spectra absorbance may provide the controller signals that the controller will control the timing of slurry sampling and the volume of dilution water. The filtrate spectra absorbance may provide the controller signals that the controller will adjust the mixing and sonication power intensity and duration.

The on-line active clay analyzer may be installed on the raw ore slurry process pipeline to provide continuous and near-real time information on clay content and clay activity of raw ore, so the optimal blending ratio can be determined to maximize the ore processing capacity and/or to avoid out-of-spec load to the system. It may also provide continuous and near real-time process control for accurate flocculant dosages and achieve better slurry dewatering, settling and rheological performances. In some embodiments, the on-line active clay analyzer may be used configured as a mobile analytical device to provide at-line analysis near the process area.

The on-line active clay analyzer may be used in a tailings pipeline where flocculation is required to dewater the slurry. Or it may be used for any mining and mineral processes where accurate clay activity and content information is required to reduce production cost, improve ore processability, improve solids-water separation or other process performance, recover more water and reduce tailings volume/footprint. For example, the on-line active clay analyzer may be used for potash, kimberlite, gold, uranium, oil sands fluid fine tailings (FFT) and mature fine tailings (MFT) from oil sands operations, or any mining and minerals containing clay and active clays. The on-line active clay analyzer may be used at different stages of mining operation, including but not limited to survey, planning, production, transportation and reclamation, and the like.

The on-line active clay analyzer can be used for slurry samples, or for samples in other forms of minerals such as powder, suspensions, sludge, slimes, paste, and the like.

Some general implementations of the present invention may be as follows:

Ore blending and feed stream optimization: the on-line active clay analyzer can be used to identify and quantify active clay and clay activity in raw ores, so ore or feed material may be blended according to the operation specifications. Feed stream optimization can minimize active clay challenges at the start and limit the chance it being passed on to the downstream.

Tailings flocculation and dewatering: the on-line active clay analyzer can be used to determine the slurry clay activity and clay content in the tailings streams, so that active clays in mineral slurry can be quickly identified and quantified, chemical coagulant and flocculant dosages can be adjusted accordingly to save operating cost and achieve effective process control.

Mine survey and planning: the on-line active clay analyzer can be used to obtain the distribution of clay and active clay in mineral deposit prior to the operation. The clay information will help to design a more effective process and tailings management plan based on the active clay distributions.

Processes other than tailings flocculation: the on-line active clay analyzer can be used to processes such as flotation, extraction, hydrocyclone, hydrotransportation, settling and consolidation, drilling mud selection and operation, as clay and active clay impact these processes by tying up water and chemicals, hindering solids settling, increasing rheology and friction, and causing difficulties to water recovery.

Geotechnical practice: the on-line active clay analyzer can be used to determine mineral's active clay content which can be used to correlate to geotechnical parameters such as Atterberg Limits, soil permeability and plasticity. Clay and active clay are important components of soil and foundation materials, their presence can greatly impact the geotechnical performances and foundation stability.

Different minerals and forms of mixtures: the on-line active clay analyzer can be used for potash, kimberlite, gold, uranium, oil sands fluid fine tailings and mature fine tailings from oil sands operations, etc. In some implementations, the analyzer can be used for other forms of clay-bearing mixtures such as powder, suspensions, sludge, and the like.

Methylene blue is one example of a cationic dye that works well in active clay analysis and has been adopted as the industry standard for active clay content analysis. However, other cationic dyes would work with the present invention, in particularly, the cationic dyes that absorb spectra in the UV/Visible wavelengths that can be measured by commercially available spectrophotometers, are stable and widely and commercially available, and are low in cost are preferred. Methylene blue has these characteristics. Some examples of other cationic dyes that have similar characteristics, though not an exhaustive list, are chrysoidine (basic orange) and methyl violet (basic violet).

While embodiments of the invention have been described and illustrated, such embodiments should be considered illustrative of the invention only. The invention may include variants not described or illustrated herein in detail. Thus, the embodiments described and illustrated herein should not be considered to limit the invention.

What is claimed is:

1. An automated active clay analyzer apparatus for analyzing active clays in a mineral slurry in a vessel or passing through a conduit, the apparatus comprising:
controller operable to manage the operations associated with the apparatus;
an automatic sampler coupled to the vessel or conduit and operable to extract a sample of a determined volume of the slurry from the vessel or conduit, the automatic sampler being under control of the controller;
at least one fluid delivery device under control of the controller and operable to deliver a known volume of water and a known volume of cationic dye into the sample;
a mixing chamber that receives the sample;
an agitator operable to agitate the sample, the water and the cationic dye in the mixing chamber to produce a diluted sample mixture;
an automatic filter operable to filter the diluted sample mixture to produce a filtrate; and
a spectrophotometer having an optical flow cell that receives the filtrate from the automatic filter and is operable to measure a spectra absorbance of the filtrate in the optical flow cell using at least one wavelength to obtain spectra absorbance data of the filtrate that may be used to control the processing of the mineral slurry or other aspects of a mineral processing operation related to the mineral slurry in near real time.

2. The apparatus as claimed in claim 1, wherein apparatus is on-line such that the sample is withdrawn from an on-line active process.

3. The apparatus as claimed in any one of claims 1-2, wherein the controller is operable to instruct the automatic sampler to extract the sample from the vessel or conduit.

4. The apparatus as claimed in any one of claims 1-3, wherein the controller is operable to instruct the at least one fluid delivery device to flush the sample out of the automatic sampler after the sample has been extracted by the automatic sampler.

5. The apparatus as claimed in any one of claims 1-4, wherein the at least one fluid delivery device comprises a water fluid delivery device that cooperates with the automatic sampler to deliver the volume of water into the extracted sample to flush it out of the automatic sampler to clean the automatic sampler thereby ready it for obtaining a subsequent sample of slurry.

6. The apparatus as claimed in any one of claims 1-5, wherein the agitator is under control of the controller.

7. The apparatus as claimed in claim 6, wherein the controller is operable to instruct the agitator to mix the sample mixture after the sample mixture is received in the mixing chamber.

8. The apparatus as claimed in any one of claims 1-7, wherein the at least one fluid delivery device is further operable to deliver a volume of one or more chemicals into the sample in or upstream of the mixing chamber to chemically condition the sample.

9. The apparatus as claimed in any one of claims 1-8, wherein the at least one fluid delivery device further comprises a methylene blue dye fluid delivery device that cooperates with the mixing chamber to deliver the volume of methylene blue into the diluted sample mixture in the mixing chamber.

10. The apparatus as claimed in any one of claims 1-9, wherein the at least one fluid delivery device further comprises at least one chemical fluid delivery device operable to deliver a volume of one or more chemicals into the diluted sample in the mixing chamber to chemically condition the diluted sample.

11. The apparatus as claimed in any one of claims 1-10, wherein the spectrophotometer is operable to measure a spectra absorbance of the filtrate in the optical flow cell using plurality of wavelengths to obtain spectra absorbance data of the filtrate.

12. The apparatus as claimed in claim 11, wherein the plurality of wavelengths is in the range of 500 nm-800 nm.

13. The apparatus as claimed in any one of claims 1-12, wherein the automatic filter and the spectrophotometer are each under control of the controller.

14. The apparatus as claimed in claim 13, wherein the controller is operable to instruct the automatic filter to extract the aliquot from the mixing vessel and convey the aliquot to the flow cell of the spectrophotometer.

15. The apparatus as claimed in any one of claims 1-14, wherein the controller is operable to instruct the spectrophotometer to measure the spectra absorbance of the filtrate after the filtrate is received in the flow cell.

16. The apparatus as claimed in any one of claims 1-15, wherein the cationic dye is methylene blue.

17. The apparatus as claimed in any one of claims 1-16, wherein the automatic sampler is mounted on the vessel or conduit and includes a sample extraction portion that communicates with an internal lumen of the vessel or conduit containing the mineral slurry.

18. The apparatus as claimed in any one of claims 1-17, further comprising a sonic homogenizer to disperse clay particles in the diluted sample mixture.

19. The apparatus as claimed in claim 18, wherein the sonic homogenizer cooperates with the mixing chamber to homogenize the sample mixture in the mixing chamber.

20. The apparatus as claimed in any one of claims 1-19, further comprising a pH probe located in the mixing chamber to measure the pH of the sample mixture.

21. The apparatus as claimed in any one of claims 1-20, wherein the at least one fluid delivery device is operable to deliver sequential volumes of cationic dye solution into the diluted sample mixture within the mixing chamber.

22. The apparatus as claimed in claim 21, wherein the controller is operable to instruct the at least one fluid delivery device to deliver a volume of cationic dye solution into the sample mixture after an aliquot is withdrawn from the mixing chamber.

23. The apparatus as claimed in any one of claims 1-22 wherein the at least one fluid delivery device is operable to flush water through one or both of the automatic sampler and the mixing chamber to clean them in preparation for processing a subsequent sample.

24. The apparatus as claimed in any one of claims 1-23, further comprising a temperature regulating device under control of the controller and cooperating with the mixing chamber to maintain the diluted sample mixture at a set temperature.

25. The apparatus as claimed in claim 24 wherein the temperature regulating device comprises a fluid jacket around a portion of the mixing chamber having a flow of hot fluid or cold fluid circulating through the fluid jacket.

26. The apparatus as claimed in any one of claims 1-25, further comprising a memory storage media to store measurement data generated by the apparatus.

27. The apparatus as claimed in any one of claims 16-26, further comprising a data processor operable to process spectral absorption data measured by the spectrophotometer for the sample and derive a methylene blue index for the slurry sample from the spectra absorbance data.

28. The apparatus as claimed in any one of claims 1-27, wherein the automatic filter comprises:
a second automatic sampler coupled to the mixing chamber and operable to extract the aliquot from the mixing chamber after each delivery of the cationic dye; and
a filter element downstream of the second automatic sampler, wherein the second automatic sampler pumps the aliquot through the filter element and the filtrate to the optical flow cell for obtaining spectra absorbance measurements of each filtrate.

29. The apparatus as claimed in claim 28, wherein the automatic filter includes a pressure sensor that senses pressure of the aliquot upstream of the filter element; and a mechanism operable to replace the filter element with a fresh filter element as a result of a signal from the pressure sensor that the pressure of the aliquot has increased beyond a specified pressure.

30. An active clay analysing system for analyzing active clays in a mineral slurry in a vessel or passing through a conduit, the system comprising the clay analyzer apparatus as claimed in any one of claims 1-29 and a density measuring device near said clay analyzer apparatus that measures the density of the slurry.

31. A method of automatically analyzing active clays in a mineral slurry in a vessel or passing through a conduit, the method comprising the steps of:
a. providing a controller operable to manage the operations associated with the process;
b. coupling an automatic sampler with the vessel or conduit such that the automatic sampler is operable to extract a sample of a known volume of the slurry from the vessel or conduit;
c. providing instructions from the controller to the automatic sampler to extract the sample;
d. flushing the sample from the automatic sampler with a volume of water into a mixing chamber using at least one fluid delivery device under control of the controller;
e. mixing the sample and water in the mixing chamber to provide a diluted sample mixture;
f. providing instructions from the controller to the at least one fluid delivery device to add a known volume of a cationic dye into the diluted sample mixture;
g. filtering an aliquot of the dyed diluted sample mixture through filter media of an automatic filter and directing a filtrate of the aliquot into an optical flow cell of a spectrophotometer;
h. providing instructions from the controller to the spectrophotometer to measure spectra absorbance of the filtrate to obtain spectra absorbance data of the filtrate, and storing the data in memory;
i. repeating steps (f) to (h) until a target spectra absorbance value or a plurality of target spectra absorbance values is reached;
j. flushing water through the automatic sampler and mixing chamber to expel remnants of the slurry sample and process solutions therefrom in preparation for processing a subsequent sample; and
k. analyzing the data set and using a result of the analysis in controlling processing of the mineral slurry or other aspects of a mineral processing operation related to the mineral slurry.

32. The method as claimed in claim 31 wherein the cationic dye is methylene blue and the result of the data analysis includes a methylene blue index of each sample.

33. The method as claimed in any one of claims 31-32, further comprising a step of sonically homogenizing the sample mixture before and after adding dye to disperse clay particles in the sample mixture.

34. The method of claim 33, wherein the step of sonically homogenizing the dyed sample mixture takes place in the mixing chamber.

35. The method as claimed in any one of claims 31-34, further comprising a step of measuring the density of the slurry sample in the vessel or conduit near the analyzer.

36. The method as claimed in any one of claims 31-35, further comprising measuring a pH of the diluted sample mixture and correlating the measured pH to a pH of the original slurry sample.

37. The method as claimed in any one of claims 31-36, further comprising regulating a temperature of the dyed sample mixture in the mixing chamber under control from the controller.

38. The method as claimed in claim 37 wherein the step of regulating a temperature of the dyed diluted sample mixture comprises establishing a flow of hot fluid or cold fluid through a fluid jacket provided around at least a portion of the mixing chamber.

39. The method as claimed in any one of claims 31-38 further comprising repeating steps (c) to (j) to obtain a data set on a desired number of samples.
